(19) United States
(12) Patent Application Publication
(10) Pub. No.: US 2012/0221594 A1
(43) Pub. Date: Aug. 30, 2012

(54) ELECTRONIC DEVICE AND METHOD OF DISPLAYING DESIGN PATENTS

(75) Inventors: WEI-QING XIAO, Shenzhen (CN); CHUNG-I LEE, Tu-Cheng (TW); CHIEN-FA YEH, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/332,378

(22) Filed: Dec. 21, 2011

(30) Foreign Application Priority Data
Feb. 28, 2011 (CN) 201110047555.8

(51) Int. Cl. G06F 17/30

(52) U.S. Cl. 707/769; 707/E17.014; 707/E17.019

(57) ABSTRACT

An electronic device and method of displaying design patents receives search conditions, and searches at least one image of a design patent from a database server. An image is selected from the searched images, to acquire a design patent that contains the selected image and acquire all images of the design patent. A cubic box is created. The images of the design patent are superimposed onto the surfaces of the cubic box, to generate a cubic view of the design patent. Each of the search conditions and one or more cubic views corresponding to the search condition is recording into a search list. All contents of each of the design patents corresponding to the cubic views in a single page.

### BACKGROUND

1. Technical Field

Embodiments of the present disclosure relate to devices and methods for displaying images, and more particularly to an electronic device and a method of displaying a design patent.

2. Description of Related Art

Intellectual Property (often referred to as “IP”) plays a key role in corporations and can be very valuable. Patents are the most powerful weapon in protecting IP technology. Patents include utility patents and design patents. A design patent is a patent granted on the ornamental design of a product.

Almost all the patents are published on the Internet. Usually, a patent includes much content that needs a plurality of pages to show all the content. For example, a design patent of a product may include images, such as six views of the product, each of which may be shown on a single page. In addition, the design patent may further include character descriptions of the product referring to the six views. The character descriptions may be shown on another one or more pages. Thus, a problem happens, a user can only browse the design patent one page at a time via the Internet. The user cannot browse the character descriptions and the six views of the product together. It is inconvenient and time consuming to switch between each of the six views and the character descriptions.

### BRIEF DESCRIPTION OF THE DRAWINGS

FIG. 1 is a block diagram of one embodiment of an electronic device including a design patent displaying system.

FIG. 2 is a block diagram of one embodiment of function modules of the design patent displaying system of FIG. 1.

FIG. 3 is a flowchart of one embodiment of a method of displaying design patents.

FIG. 4 is an example of cubic views of a design patent.

FIG. 5 is an example of a search list relating to search conditions.

FIG. 6 is an example of a nine-grid displaying all content of a design patent.

### DETAILED DESCRIPTION

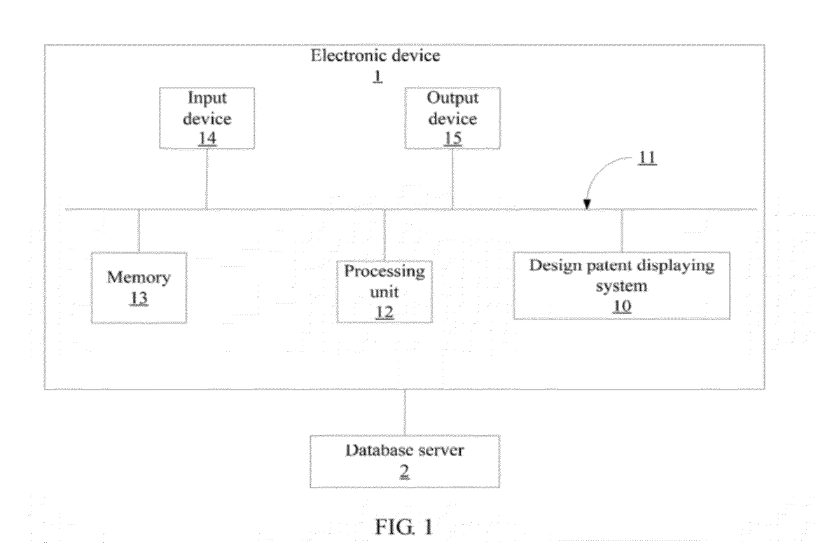

FIG. 1 is a block diagram of one embodiment of an electronic device 1 including a design patent displaying system 10. The electronic device 1 may further include components such as a bus 11, a processing unit 12, a memory 13, an input device 14, and an output device 15. One skilled in the art would recognize that the electronic device 1 may be configured in a number of other ways and may include other or different components. The electronic device 1 may be a computer, a smart phone, a personal digital assistant (PDA), for example, depending on different embodiments.

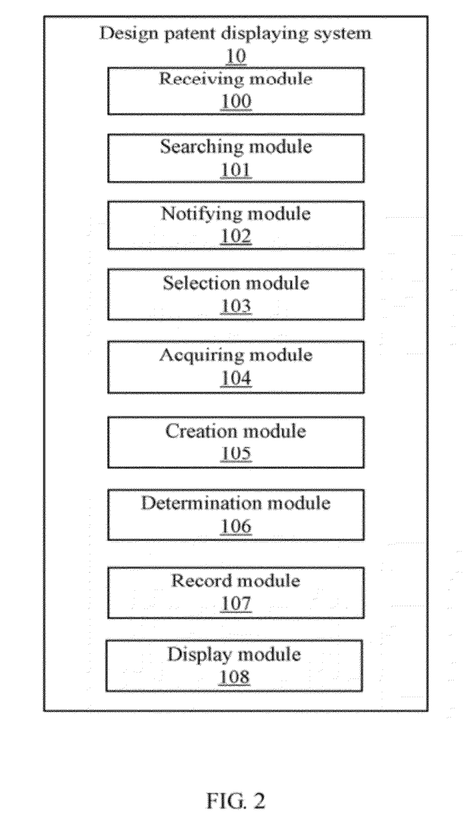

The design patent displaying system 10 includes a number of function modules (depicted in FIG. 2). The function modules may include computerized code in the form of one or more programs, which have a function of showing most design patent contents on a single page.

The bus 11 permits communication among the components, such as the processing unit 12, the memory 13, the input device 14, and the output device 15.

The processing unit 12 may include a processor, a microprocessor, an application-specific integrated circuit (ASIC), and a field programmable gate array, (FPGA) for example. The processing unit 12 may execute the computerized code of the function modules of the design patent displaying system 10 to realize the functions of the design patent displaying system 10.

The memory 13 may include a random access memory (RAM) or other type of dynamic storage device, a read only memory (ROM) or other type of static storage device, a flash memory, such as an electrically erasable programmable read only memory (EEPROM) device, and/or some other type(s) of computer-readable storage medium, such as a hard disk drive, a compact disc, a digital video disc, or a tape drive. The memory 13 stores the computerized code of the function modules of the design patent displaying system 10 for execution by the processing unit 12.

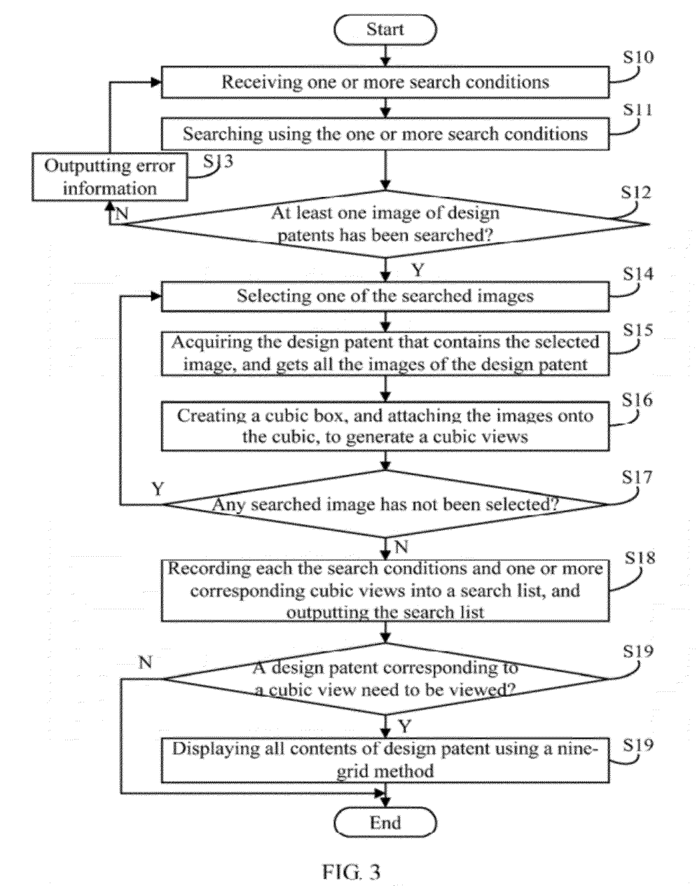

The input device 14 may include a mechanism that permits a user to input data, such as search conditions, to the electronic device 1. The input device 14 may be, a microphone, a keyboard, a keypad, a mouse, a pen, voice recognition and/or biometric mechanisms, for example. The output device 15 may include one or more mechanisms that output data, such as a search list and a nine-grids which are described and defined below in FIG. 3, to the user. The output device 15 may include a display, a printer, one or more speakers, for example.

The electronic device 1 connects with a database server 2 using a network (not shown). The network may be the Internet or an intranet depending on different embodiments. The database server 2 stores a plurality of design patents in the form of electronic files. Each of the design patents includes at least one page which displays an image of a product. The image may be a front view, a left view, a top view, a back view, a right view, and/or a bottom view of the product.

FIG. 2 is a block diagram of one embodiment of the function modules of the design patent displaying system 10. In one embodiment, the design patent displaying system 10 may include a receiving module 100, a searching module 101, a notifying module 102, a selection module 103, an acquiring module 104, a creation module 105, a determination module 106, a record module 107, and a displaying module 108. The function modules 100-108 provide the functions illustrated in FIG. 3.

FIG. 3 is a flowchart of one embodiment of a method of displaying design patents. Depending on the embodiment, additional blocks may be added, others removed, and the ordering of the blocks may be changed.

In block S10, the receiving module 100 receives one or more search conditions that are used for searching one or more design patents from the database server 2. The search conditions may include, but are not limited to, one or more keywords, and one or more searchable images. Each of the keywords include one or more characters describing an image in a design patent. In one embodiment, the search conditions are input by a user through an user interface (UI, not shown) provided by the design patent displaying system 10 using the input device 14.

In block S11, the searching module 101 searches the database server 2 using the one or more search conditions, and in block S12, the searching module 101 determines if at least one image of a design patent has been searched from the database server 2 according to the one or more search conditions. Block S13 is implemented if no image of any design patent has been searched. Otherwise, block S14 is implemented if an image of any design patent has been searched.

In block S13, the notifying module 102 outputs error information for prompting the user to input other search conditions. In one embodiment, the error information is output through the UI of the design patent displaying system 10 using the output device 15.

In block S14, the selection module 103 selects one image from the searched images. The selection of the image from the searched images may be at random or may be according to a similarity of each of the searched images and the search condition.

In block S15, the acquiring module 104 acquires a design patent that contains the selected image, and acquires all images of the design patent. It may be understood that all images of the design patent may include one or more of six views of a product. As known, the six views include a front view, a left view, a top view, a back view, a right view, and a bottom view.

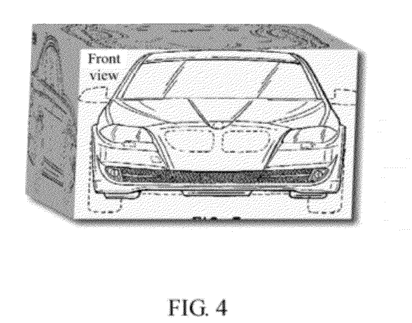

In block S16, the creation module 105 creates a cubic box, and superimposes the images of the design patent onto the six surfaces of the cubic box, to generate a cubic view of the design patent. In one embodiment, the creation module 105 superimposes the six views onto the surfaces of the cubic box. In another embodiment, if the images of the design patent only includes five views or even less than five views, the creation module 105 superimposes the five views (or less than five views, for example), and another one or more images of the design patent onto the surfaces of the cubic box. In another embodiment, if a number of the images of the design patent is less than six, the creation module 105 superimposes all the images of the design patent onto the surfaces of the cubic box, and leaves one or more surfaces of the cubic box blank. In one embodiment, the cubic view can rotate according to mouse movements. An example of the cubic view is illustrated in FIG. 4.

In block S17, the determination module 106 determines if any searched image has been selected by the selection module 103. Block S14 is repeated if any searched image has not been selected. Otherwise, block S18 is implemented if all the searched images have been selected.

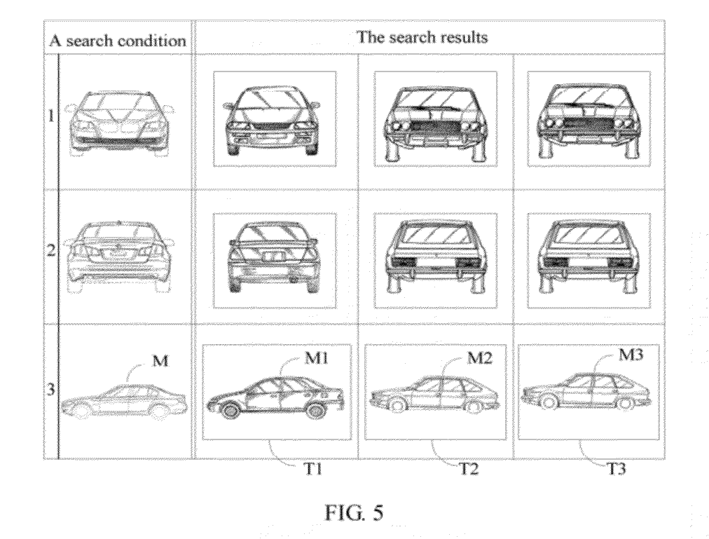

In block S18, the record module 107 records each of the search conditions and one or more cubic views corresponding to the search conditions into a search list, and outputs the search list using the output device 15. On example of the search list is illustrated in FIG. 5. In FIG. 5, character M represents a search condition. Characters M1, M2, and M3 represents searched images which are searched according to the search condition M. Characters T1, T2, and T3 represent the cubic views corresponding to the search condition M. In one embodiment, an arrangement order of the T1, T2 and T3 are according to similarities of the search condition and the searched images

In block S19, the displaying module 108 determines that if a design patent corresponding to a cubic view needs to be viewed according to click movements of the input device 14 (or touch movements on a display). In one embodiment, if the displaying module 108 detects a click movement on a cubic view of the search list, the displaying module 108 determines the design patent corresponding to the cubic view needs to be viewed.

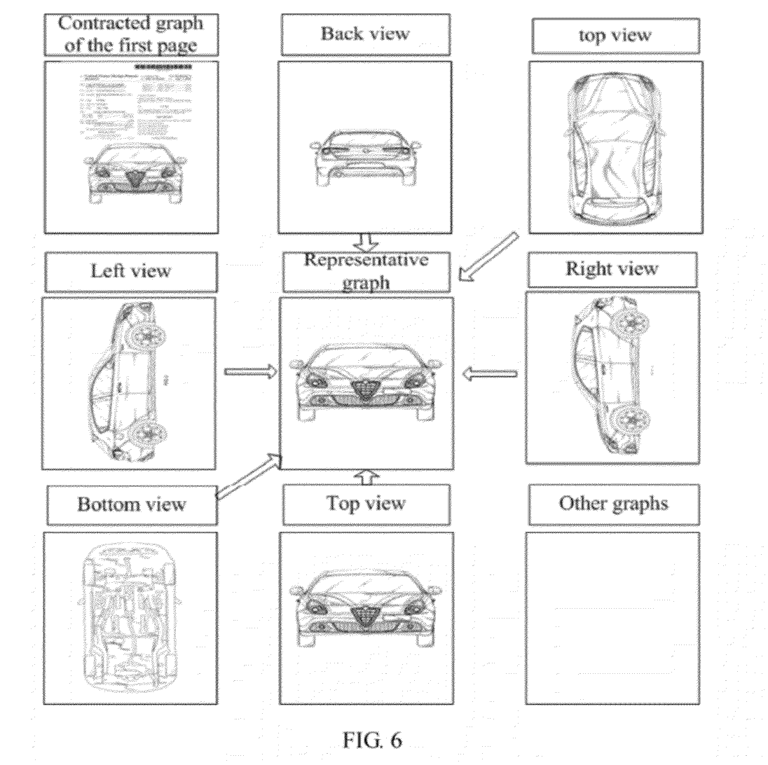

In block S20, the displaying module 108 displays all content, including images and character descriptions, of the design patent in a single page, for example using a nine-grid method, like the example illustrating in FIG. 6.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method of displaying design patents, being performed by execution of computerized code by a processor of an electronic device, and comprising:
receiving one or more search conditions from an input device of the electronic device;
searching at least one image of a design patent from a database server according to the one or more search conditions;
selecting an image from the searched images one by one, acquiring a design patent that contains the selected image, and acquiring all images of the design patent;
recording each of the search conditions and one or more cubic views corresponding to the search condition into a search list, and outputting the search list using an output device of the electronic device; and
displaying the images of each of the design patents on a cubic box using the output device of the electronic device.

2. The method according to claim 1, wherein the search conditions comprise one or more keywords and one or more searchable images.

3. The method according to claim 1, wherein the image displayed on the cubic box comprise six views of a product.

4. The method according to claim 3, wherein the cubic view of the design patent is rotatable according to activation of mouse movements of the input device.

5. The method according to claim 1, wherein all the contents of each of the design patents corresponding to the cubic views are displayed using a nine-grid method.

6. An electronic device, comprising:
a non-transitory storage medium;
an input device;
an output device;
at least one processor; and
one or more modules that are stored in the non-transitory storage medium; and are executed by the at least one processor, the one or more modules comprising instructions to:
receive one or more search conditions from the input device;
search at least one image of a design patent from a database server according to the one or more search conditions;
select an image from the searched images one by one, acquire a design patent that contains the selected image, and acquire all the images of the design patent;
record each of the search conditions and one or more cubic views corresponding to the search condition into a search list, and output the search list using the output device; and
displaying the images of each of the design patents on a cubic box using the output device of the electronic device.

7. The electronic device according to claim 6, wherein the search conditions comprise one or more keywords and one or more searchable images.

8. The electronic device according to claim 6, wherein the image displayed on the cubic box comprise six views of a product.

9. The electronic device according to claim 6, wherein the cubic view of the design patent is rotatable according to activation of mouse movements of the input device.

10. The electronic device according to claim 6, wherein all the contents of each of the design patents corresponding to the cubic views are displayed using a nine-grid method.

11. A non-transitory storage medium having stored thereon instructions that, when executed by a processor of an electronic device, causes the processor to perform a method of displaying design patents, wherein the method comprises:
receiving one or more search conditions from an input device of the electronic device;
searching at least one image of a design patent from a database server according to the one or more search conditions;
selecting an image from the searched images one by one, acquiring a design patent that contains the selected image, and acquiring all images of the design patent;
recording each of the search conditions and one or more cubic views corresponding to the search condition into a search list, and outputting the search list using an output device of the electronic device; and
displaying the images of each of the design patents on a cubic box using the output device of the electronic device.

12. The non-transitory storage medium according to claim 11, wherein the search conditions comprise one or more keywords and one or more searchable images.

13. The non-transitory storage medium according to claim 11, wherein the image displayed on the cubic box comprise six views of a product.

14. The non-transitory storage medium according to claim 13, wherein the cubic view of the design patent is rotatable according to activation of mouse movements of the input device.

15. The non-transitory storage medium according to claim 11, wherein all the contents of each of the design patents corresponding to the cubic views are displayed using a nine-grid method.
